(19) United States
(12) Patent Application Publication
(10) Pub. No.: US 2009/0095265 A1
(43) Pub. Date: Apr. 16, 2009

(54) FUEL SUPPLY DEVICE

(75) Inventor: Koji YOSHIDA, Kasugai-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 12/246,670

(22) Filed: Oct. 7, 2008

(30) Foreign Application Priority Data
Oct. 10, 2007 (JP) 2007-264441

(51) Int. Cl. F02M 37/04

(52) U.S. Cl. 123/509

(57) ABSTRACT

A fuel supply device supplies fuel contained in a fuel tank to a combustion engine. The fuel supply device comprises an upper unit which is fixed to an installation hole formed on an upper surface of the fuel tank, a lower unit placed inside the fuel tank, a fuel pump mounted to either the upper unit or the lower unit, and a control module for controlling operation of the fuel pump. The control module is disposed inside the fuel tank. A part of the upper unit is located on one side of the control module in a horizontal direction. A part of the lower unit is located on the other side of the control module in the horizontal direction. In this structure, the control module disposed inside the fuel tank can be protected against swaying fuel.

### CROSS-REFERENCE TO RELATED APPLICATION

This application claims priority to Japanese Patent Application No. 2007-264441, filed on Oct. 10, 2007, the contents of which are hereby incorporated by reference into the present application.

### BACKGROUND OF THE INVENTION

1. Field of the Invention

The present invention relates to a fuel supply device for supplying fuel in a fuel tank to a combustion engine.

2. Description of the Related Art

Japanese Patent Laid-Open Application Publications No. 2006-233955 and No. 2006-002658 disclose fuel supply devices. Each of the fuel supply device comprises an upper unit fixed to an installation hole formed on an upper surface of a fuel tank, a lower unit disposed inside the fuel tank, a fuel pump installed in the lower unit, and a control module for controlling operation of the fuel pump. The control module has, in a casing thereof, a control circuit including elements, such as transistors, and controls, for example, electric power to be supplied to the fuel pump and the like.

For such a type of fuel supply device, it is important to suppress overheating of the control module. Various measures have been taken to prevent overheating. For example, in the fuel supply device disclosed in the aforementioned Publication No. 2006-233955, the control module disposed outside the fuel tank is provided with a radiator plate which is projected into the fuel tank. With this structure, the control module disposed outside the fuel tank can be cooled down because heat of the control module can be absorbed by fuel contained in the fuel tank. On the other hand, in the fuel supply device disclosed in the Publication No. 2006-002658, another structure is employed in which the control module is installed inside a fuel tank to directly cool the control module using fuel contained in the fuel tank.

### SUMMARY OF THE INVENTION

The control module can be cooled down using fuel contained in the fuel tank, by placing the control module inside the fuel tank. However, when fuel sways in the fuel tank, the control module disposed inside the fuel tank may receive a strong force exerted by the swaying fuel. Especially, in a fuel tank for an automobile, fuel sometimes sways intensely as the automobile travels, and the control module may in some instances be detached due to the force exerted by the fuel.

The present invention, which was conceived to address the aforesaid problems, provides a technique for preventing an excessive force exertion on a control module disposed inside a fuel tank even under a case in which fuel may sway in the fuel tank.

A fuel supply device embodied according to the present invention is configured to supply fuel contained in a fuel tank to a combustion engine, and composed of an upper unit that is fixed to an installation hole formed on an upper surface of the fuel tank, a lower unit disposed within the fuel tank, a fuel pump arranged on the lower unit, and a control module for controlling operation of the fuel pump. Further, in the fuel supply device, the control module is disposed within the fuel tank, and a part of the upper unit is located on one side of the control module in a horizontal direction with respect to the control module, while a part of the lower unit is located on the other side of the control module in the horizontal direction.

In the fuel supply device, the control module is disposed inside the fuel tank, which allows the control module to be directly cooled by fuel in the fuel tank. Further, in the fuel supply device, because parts of the upper unit and the lower unit are arranged to align horizontally with the control module, peripheral of the control module may at least in part be protected by the parts of the upper unit and the lower unit from forces that are exerted along the horizontal direction. In this sense, “the horizontal direction with respect to the control module” may be defined as a direction parallel to a direction in which force of swaying fuel is put forth. Thus, even if the fuel in the fuel tank intensely sways, strong collision of the swaying fuel against the control module is prevented. It should be noted that, aforementioned positional relationship of the upper unit, lower unit and the control module in the horizontal direction may, as well as may not, continue in a vertical direction with respect to the control module; that is, whole of the control module in the vertical (or height) direction does not have to be placed in between the parts of the upper unit and the lower unit.

In the above-described fuel supply device, the control module disposed inside the fuel tank is sufficiently cooled by means of fuel in the fuel tank, and also prevented from receiving an excessive force exerted by the swaying fuel in the fuel tank.

In the above-described fuel supply device, at least a part of the control module is preferably surrounded by at least one of the upper unit and the lower unit in the horizontal direction.

According to this configuration, the force to be exerted on the control module by the swaying fuel in the fuel tank can be remarkably suppressed in proportion to how much the control module is surrounded by the upper unit and/or the lower unit.

It is preferable that the above-described fuel supply device further comprises a coupling member that couples the upper unit with the lower unit in such a manner that relative positions of the upper unit and the lower unit are changeable. In this case, at least a part of the control module is preferably surrounded in the horizontal direction by at least one of the upper unit, the lower unit, and the coupling member. The relative positions of the upper unit and the lower unit may be changed by configuration in which one of the upper unit, lower unit or coupling member is movable, or in combination thereof. Further, the control module may, as well as may not, have a portion in the horizontal direction and vertical direction that is not surrounded by any of the upper unit, the lower unit, and the coupling member.

Also in this configuration, the control module is directly cooled by the fuel in the fuel tank, while the force to be exerted on the control module by the swaying fuel in the fuel tank is effectively suppressed.

When the above-described structure using the coupling member is employed, it is preferable that the upper unit comprises at least one first connecting portion which is slidably connected to the coupling member, and a hollow that extends in the vertical direction is formed within at least one of the first connecting portion. Further, the control module is preferably disposed in the hollow formed within the first connecting portion of the upper unit. In this configuration, the hollow extends in the vertical direction, which may also be referred to as a direction parallel to the vertical or height direction of the control module. Further, a whole or at least a part of the control module in the horizontal direction may be surrounded by the surface of the hollow; that is, the hollow may have an opening along the vertical direction.

The fuel supply device according to the present invention can be embodied in the above-described structure without making a major change in design of conventional fuel supply devices.

Alternatively, it is also effective that the above-described configuration of the upper unit may be employed in the lower unit. More specifically, the lower unit comprises at least a second connecting portion which is slidably connected to the coupling member, and a hollow that extends in the vertical direction is formed within the second connecting portion. In this case, the control module can be disposed in the hollow formed within the second connecting portion of the lower unit.

Still further, the hollow that extends in the vertical direction may be formed in the coupling member, and the control module may be disposed in the hollow thereof.

Also, the fuel supply device according to the present invention can be embodied in any one of the above-described structures without making a major change in design of conventional fuel supply devices.

In the fuel supply device according to the present invention, an area adjacent to the control module preferably communicates with an inner space of the fuel tank. This configuration may also be defined that at least a part of the control module is separated from and does not make contact with what is surrounding (i.e., one of upper unit, lower unit or coupling member, or any combination thereof).

In this structure, because fuel is caused to flow around the control module, the control module can be cooled down more effectively.

### BRIEF DESCRIPTION OF THE DRAWINGS

FIG. 1 shows a front view of a fuel supply device according to a first embodiment of the present invention;

FIG. 2 is a cross sectional view taken along a line II-II indicated in FIG. 1;

FIG. 3 shows a front view of a fuel supply device according to a second embodiment of the present invention;

FIG. 4 is a cross sectional view taken along a line IV-IV indicated in FIG. 3;

FIG. 5 shows a front view of a fuel supply device according to a third embodiment of the present invention;

FIG. 6 is a cross sectional view taken along a line VI-VI indicated in FIG. 5;

FIG. 7 shows a front view of a fuel supply device according to a fourth embodiment of the present invention;

FIG. 8 is a cross sectional view taken along a line VIII-VIII indicated in FIG. 7;

FIG. 9 shows a front view of a fuel supply device according to a fifth embodiment of the present invention;

FIG. 10 is a cross sectional view taken along a line X-X indicated in FIG. 9;

FIG. 11 is a modification example of the fuel supply device according to the fifth embodiment, and FIG. 12 shows a fuel supply device according to a sixth embodiment of the present invention.

### DETAILED DESCRIPTION OF THE INVENTION

Some of the characteristic features of the embodiments in which the present invention may be carried out are listed below.

(Feature 1) An upper unit includes a cover member for closing an installation hole formed on an upper surface of a fuel tank, and a canister in which fuel vapor in the fuel tank is reserved.

(Feature 2) A lower unit is disposed on a bottom surface of the fuel tank.

(Feature 3) The lower unit includes a reservoir container and a fuel pump. The fuel pump, which is housed in the reservoir container, sucks and discharges fuel in the reservoir container. The reservoir container is configured in such a manner that fuel is reserved in the reservoir container by a jet pump using a discharge pressure of the fuel pump.

(Feature 4) A control module is fixed to one of the upper unit and the lower unit.

(Feature 5) The control module includes electronic equipment for controlling the fuel pump and a casing for housing the electronic equipment. The casing has fluid tightness to prevent fuel flowing into the casing.

### EMBODIMENTS OF THE INVENTION

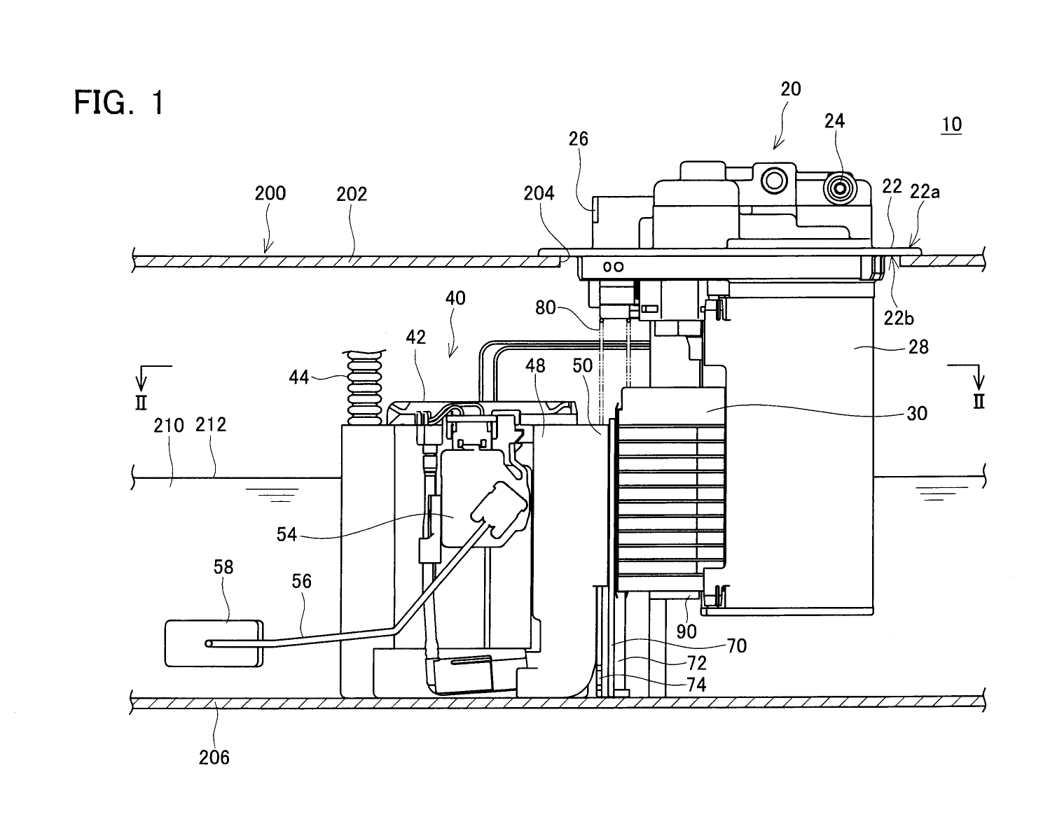

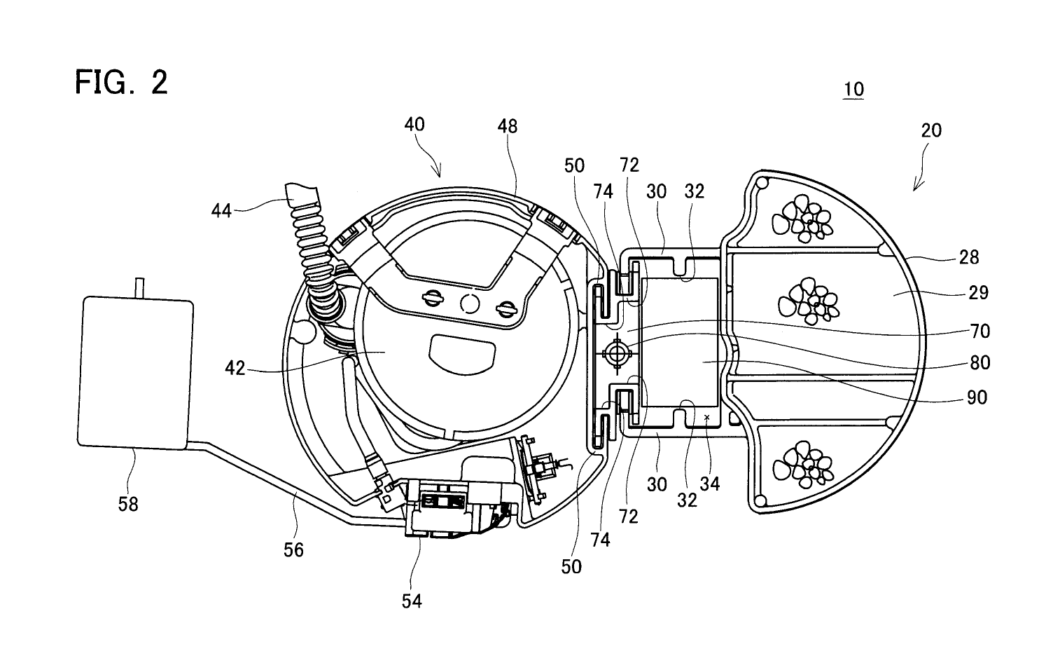

(Embodiment 1) Referring now to drawings, a fuel supply device according to Embodiment 1 of the present invention will be described. FIG. 1 shows a front view of the fuel supply device 10 according to Embodiment 1. FIG. 2 is a cross sectional view taken along a line II-II indicated in FIG. 1, and shows a transverse section of the fuel supply device 10 of Embodiment 1. As shown in FIG. 1, the fuel supply device 10 according to Embodiment 1 is attached to a fuel tank 200 for an automobile or the like for supplying fuel 210 stored in the fuel tank 200 to a combustion engine, such as the engine of the automobile. Here, the fuel 210 is a liquid fuel such as gasoline, and a fluid level 212 of the fuel 210 is generally in uniform in a horizontal direction. It should be noted that, in FIG. 1, a right and left direction corresponds to the horizontal direction, while a top and bottom direction corresponds to a vertical direction.

As shown in FIGS. 1 and 2, the fuel supply device 10 of Embodiment 1 is composed mainly of an upper unit 20, a lower unit 40, a coupling member 70 for coupling the upper unit 20 and the lower unit 40 to each other, and a control module 90. The control module 90 is fixed to the upper unit 20. It should be noted that the control module 90 may be fixed to components other than the upper unit 20. In addition, a spring 80 for biasing the coupling member 70 against a bottom surface 206 of the fuel tank 200 is inserted between the upper unit 20 and the coupling member 70. The coupling member 70 is placed substantially vertical to the bottom surface 206 of the fuel tank 200, and is extended in the vertical direction within the fuel tank 200.

The upper unit 20 is installed in an installation hole 204 formed on an upper surface 202 of the fuel tank 200. The upper unit 20 mainly comprises a set plate 22, which serves as a cover member for closing the installation hole 204, and a canister 28 in which fuel vapor in the fuel tank 200 is reserved. The set plate 22 is made of resin material. The canister 28 is attached to a lower surface 22b side of the set plate 22 and located inside the fuel tank 200. The canister 28 contains therein an absorbent (such as, for example, activated carbon) 29 to absorb fuel vapor. An exhaust port 24 from which the fuel 210 is discharged and a connector 26 for establishing electric connection with an external control device are mounted on an upper surface 22a side of the set plate 22. The connector 26 is electrically connected to the control module 90. In the present Embodiment, the lower part of the upper unit 20 is installed inside the fuel tank 200, while the upper part of the upper unit 20 is exposed to outside of the fuel tank 200. However, the upper unit 20 may be arranged in other positional configurations.

As shown in FIG. 2, formed on the upper unit 20, is one pair of first connecting portions 30 connected to the coupling member 70. The pair of first connecting portions 30 is made of resin material, and integrally formed with a casing of the canister 28 which is also made of resin material. The first connecting portions 30 extend in parallel with each other toward the coupling member 70 in the horizontal direction. Each end of the first connecting portions 30 is loosely fitted into a connected object 72 which is formed in a slot shape on the coupling member 70. The first connecting portions 30 are slidably engaged with the connected objects 72 of the coupling member 70, respectively.

A hollow 34 that extends in the vertical direction is formed between the first connecting portions 30 of the pair, and the control module 90 is disposed within the hollow 34. Protrusions 32 protruding toward the control module 90 in the horizontal direction are respectively formed on the first connecting portions 30, to thereby maintain a certain gap between the first connecting portions 30 and the control module 90. The hollow 34 where the control module 90 is disposed (specifically, the gap maintained between the control module 90 and the first connecting portions 30) communicates with an inner space of the fuel tank 200 at both top and bottom ends of the hollow 34 in the vertical direction (i.e. both the top and bottom ends of the hollow 34 in the vertical direction are open). Thus, the fuel 210 in the fuel tank 200 can easily flow in and flow out the hollow 34 where the control module 90 is disposed.

As shown in FIGS. 1 and 2, the lower unit 40 is fully placed inside the fuel tank 200, and, more specifically, fixed to the bottom surface 206 of the fuel tank 200. The lower unit 40 mainly includes a fuel pump 42, a reservoir container 48, and a filter (not illustrated). The fuel pump 42 is housed in the reservoir container 48. The fuel pump 42 sucks the fuel 210 contained in the reservoir container 48 and discharges the sucked fuel 210 through a discharge pipe 44 from the exhaust port 24. The reservoir container 48 is configured in such a manner that the fuel 210 in the fuel tank 200 is stored in the reservoir container 48 by a jet pump (not illustrated) using a discharge pressure of the fuel pump 42. The fuel 210 drawn and discharged by the fuel pump 42 is filtrated through the filter. The fuel pump 42 is electrically connected to the control module 90, and operation of the fuel pump 42 is controlled by the control module 90.

In addition, the lower unit 40 is also equipped with a fuel level gauge consisting of a sensor unit 54, an arm 56 extending from the sensor unit 54, and a float 58 fixed to an end of the arm 56. It should be noted that, though the fuel pump 42 is included in the lower unit 40 in the present embodiment, the fuel pump 42 and the necessary peripheral members may be arranged on the upper unit 20 side.

As shown in FIG. 2, a second connecting portion 50 connected to the coupling member 70 is formed on the lower unit 40. The second connecting portion 50 is made of resin material, and integrally formed with the reservoir container 48 which is also made of resin material. The second connecting portion 50 is loose-fitted to connected objects 74 formed of on the respective sides of the coupling member 70. Because the second connecting portion 50 is slidably connected to each of the connected objects 74 of the coupling member 70, the lower unit 40 and the coupling member 70 are slidably connected to each other in the vertical direction. In other words, the lower unit 40 is movably guided by the coupling member 70 in the vertical direction along the coupling member 70. It should be noted that, the second connecting member 50, as in the case with the aforementioned first connecting members 30, may be composed of two pieces of connecting member that serves as a pair.

As can be clearly understood from the above description, the upper unit 20 and the lower unit 40 are connected via the coupling member 70 to each other, and relative positions of the upper unit 20 and the lower unit 40 in the vertical direction are accordingly changeable. In such a configuration, even when a distance between the upper surface 202 and the bottom surface 206 of the fuel tank 200 is changed due to variations in internal pressure of the fuel tank or due to an external force applied to the fuel tank 200, because the upper unit 20 and the lower unit 40 can change their relative positions in the vertical direction by sliding, an undesirable extra force exerted on the upper unit 20, the lower unit 40, the fuel tank 220, and other components can be prevented. It should be noted that, the fuel supply device 10 may comprise just one of the aforementioned sliding mechanism (i.e., the sliding mechanism of first connected members 30 and the connected objects 72 and the sliding mechanism of second connected member 50 and the connected objects 74). Further, the fuel supply device 10 may comprise other mechanisms that can change the aforementioned relative positions.

The control module 90 has a metallic casing in which electronic equipment such as a power transistor is incorporated. The control module 90 adjusts, by means of the electronic equipment, a voltage to be applied to the fuel pump 42 while increasing or decreasing the voltage. The electronic equipment incorporated into the control module 90 generates heat during operation, which causes a rise in temperature of the control module 90. Here, in the fuel supply device 10 according to Embodiment 1, because the control module 90 is disposed in the fuel tank 200, the control module 90 is directly cooled by the fuel 210 in the fuel tank 200. As a result, an abnormal rise in temperature in the control module 90 is prevented.

In addition, the hollow 34 where the control module 90 is disposed (or the gap therein) communicates with the inner space of the fuel tank 200 at the upper end and the lower end of the hollow 34 in the vertical direction. According to the above-described configurations, the fuel 210 constantly circulates through the hollow 34 where the control module 90 is disposed, and thereby sufficiently cools down the control module 90.

The control module 90 placed in the fuel tank 200 may receive, when the fuel 210 sways in the fuel tank 200, a great force from the swaying fuel 210. Especially, in the fuel tank 200 for an automobile, the fuel 210 may intensely sway as the automobile travels, which would cause a problem that the control module 90 is detached by the force received from the fuel 210.

To prevent the problem from occurring, the control module 90 is disposed between the upper unit 20 and the lower unit 40 in the horizontal direction (refer to FIG. 1) in the fuel supply device 10 according to Embodiment 1. More specifically, a part of the upper unit 20 is arranged on one side (the right side in FIG. 1) of the control module 90 in the horizontal direction, while a part of the lower unit 40 is arranged on the other side (the left side in FIG. 1) of the control module 90 in the horizontal direction. In this arrangement, even when the fuel 210 intensely sways in the fuel tank 200, the swaying fuel 210 is blocked by the part of the upper unit 20 and the part of the lower unit 40 in the vicinity of the control module 90, so that strong collision of the fuel 210 with the control module 90 along the horizontal direction in which they align is prevented.

Further, in the fuel supply device 10 according to Embodiment 1, the control module 90 is disposed in the hollow 34 between the paired first connecting portions 30 extended horizontally from the upper unit 20, thereby realizing a structure in which peripheral of the control module 90 is surrounded by the upper unit 20 and the coupling member 70 in a horizontal plane that includes the horizontal direction. As a result, even when the fuel 210 intensely sways in the fuel tank 200, the swaying of the fuel 210 is highly restricted in the hollow 34 where the control module 90 is disposed. Therefore, the strong collision between the fuel 210 and the control module 90 along any direction within the horizontal plane thereof is surely prevented.

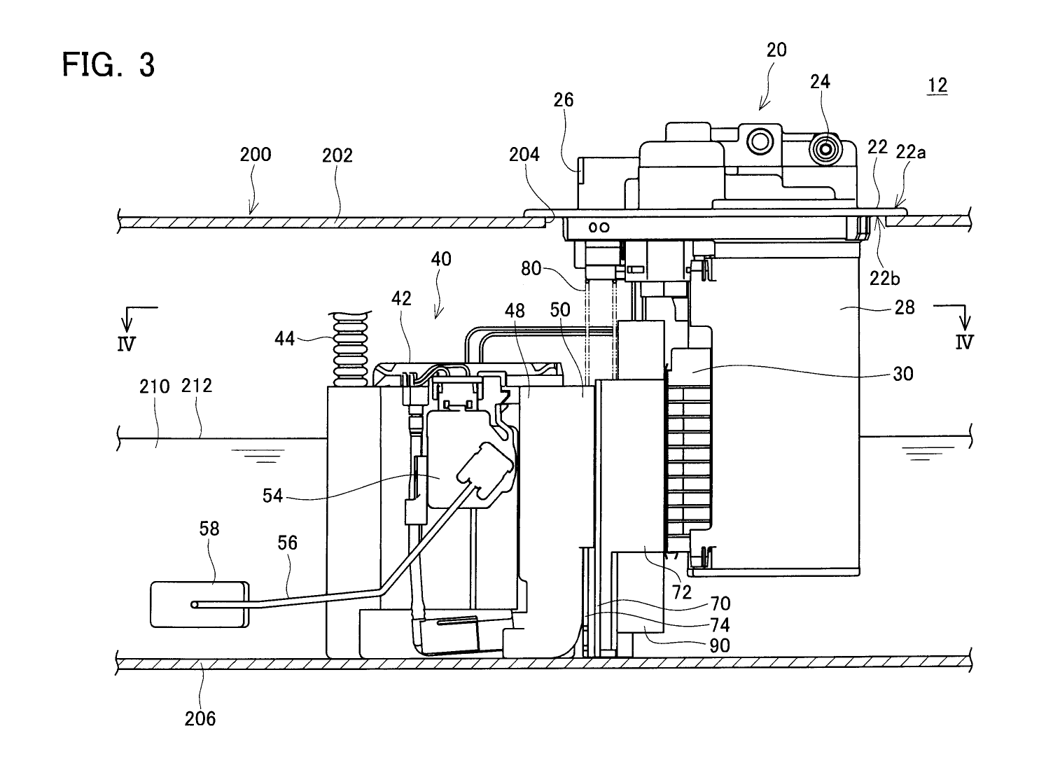

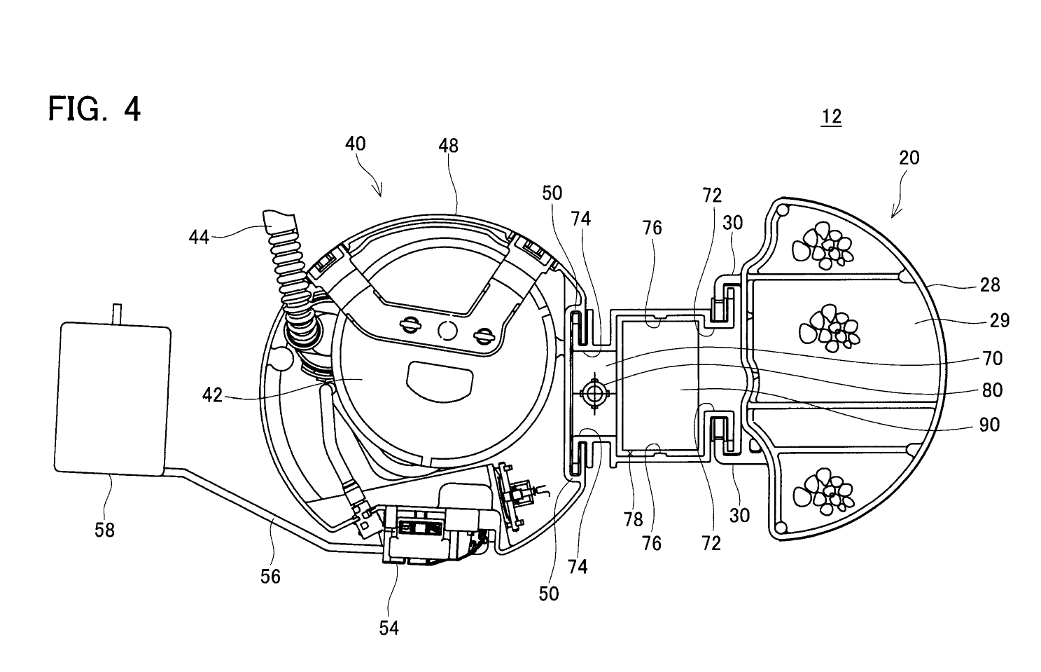

(Embodiment 2) A fuel supply device according to Embodiment 2 of the present invention will be described with reference to drawings. FIG. 3 shows a front view of the fuel supply device 12 according to Embodiment 2. FIG. 4 is a cross sectional view taken along a line IV-IV indicated in FIG. 3, and shows a transverse section of the fuel supply device 12 according to Embodiment 2. The fuel supply device 12 of Embodiment 2 shown in FIGS. 3 and 4 may be obtained by modifying a partial structure of the fuel supply device 10 of Embodiment 1 shown in FIGS. 1 and 2. In the description about the fuel supply device 12 of Embodiment 2 provided below, components which are in common with those of the fuel supply device 10 of Embodiment 1 are designated by the same reference numerals, and the descriptions related to those components may be abbreviated.

As shown in FIGS. 3 and 4, the first connecting portions 30 of the upper unit 20 are shortened in the horizontal direction in the fuel supply device 12 of Embodiment 2 as compared with those in the fuel supply device 10 of Embodiment 1, and the coupling member 70 is accordingly extended toward the first connecting portions 30 of the upper unit 20 by an amount approximately equivalent to the shortened portion of the first connecting portions 30. Then, a hollow 78 that extends in the vertical direction is formed in the coupling member 70, and the control module 90 is disposed within the hollow 78. The hollow 78 where the control module 90 is disposed communicates with the inner space of the fuel tank 200 at upper and lower ends of the hollow 78 in the vertical direction, thereby realizing a structure in which the fuel 210 in the fuel tank 200 can easily flow in and out of the hollow 78. In addition, protrusions 76 protruding toward the control module 90 are formed on the coupling member 70 to maintain a gap between the coupling member 70 and the control module 90 thereby securing a path in which fuel 210 can flow through.

In the fuel supply device 12 of Embodiment 2, because the control module 90 is disposed inside the fuel tank 200 as with the fuel supply device 10 of Embodiment 1, the control module 90 is directly cooled by the fuel 210 in the fuel tank 200. In this way, an abnormal rise in temperature of the control module 90 can be prevented.

Further, the hollow 78 where the control module 90 is disposed communicates with the inner space of the fuel tank 200 at the upper and lower ends of the hollow 78 in the vertical direction, and the gap between the coupling member 70 and the control module 90 is maintained by the protrusions 76 formed on the coupling member 70. According to the above-described configurations, the fuel 210 constantly flows through the hollow 78 where the control module 90 is disposed, to thereby sufficiently cool down the control module 90.

Also, in the fuel supply device 12 of Embodiment 2, the control module 90 is disposed between the upper unit 20 and the lower unit 40 in the horizontal direction (refer to FIG. 3) as with the fuel supply device 10 of Embodiment 1. More specifically, the upper unit 20 is arranged on one side (the right side in FIG. 3) of the control module 90 in the horizontal direction, while the lower unit 40 is arranged on the other side (the left side in FIG. 3) of the control module 90 in the horizontal direction. In this arrangement, even when the fuel 210 intensely sways in the fuel tank 200, the swaying of the fuel 210 is effectively blocked in the vicinity of the control module 90, so that strong collision of the fuel 210 with the control module 90 along the aforementioned horizontal direction is prevented.

Further, in the fuel supply device 12 of Embodiment 2, the control module 90 is disposed in the hollow 78 formed by the coupling member 70 to establish a structure in which the control module 90 is surrounded by the upper unit 20 and the coupling member 70 in a horizontal plane. In this way, even when the fuel 210 intensely sways in the fuel tank 200, the swaying of the fuel 210 in the fuel tank 200 is highly restricted in the hollow 78 where the control module 90 is disposed. Therefore, the strong collision between the fuel 210 and the control module 90 along any direction within the horizontal plane thereof is surely prevented.

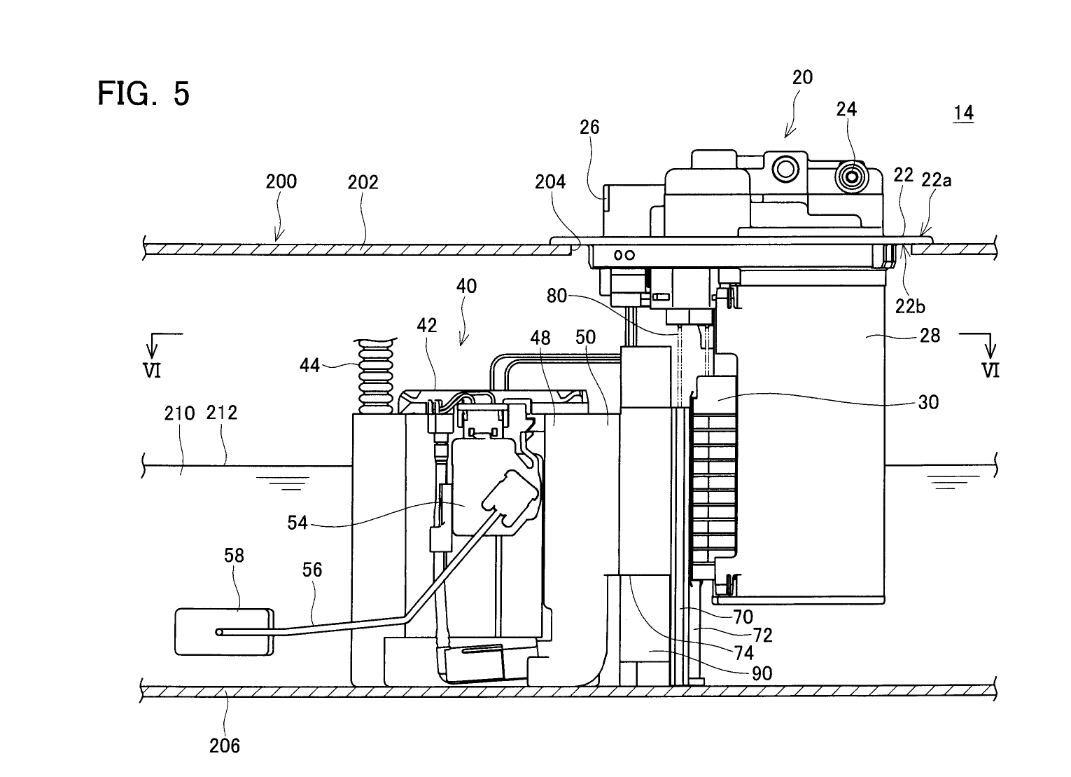

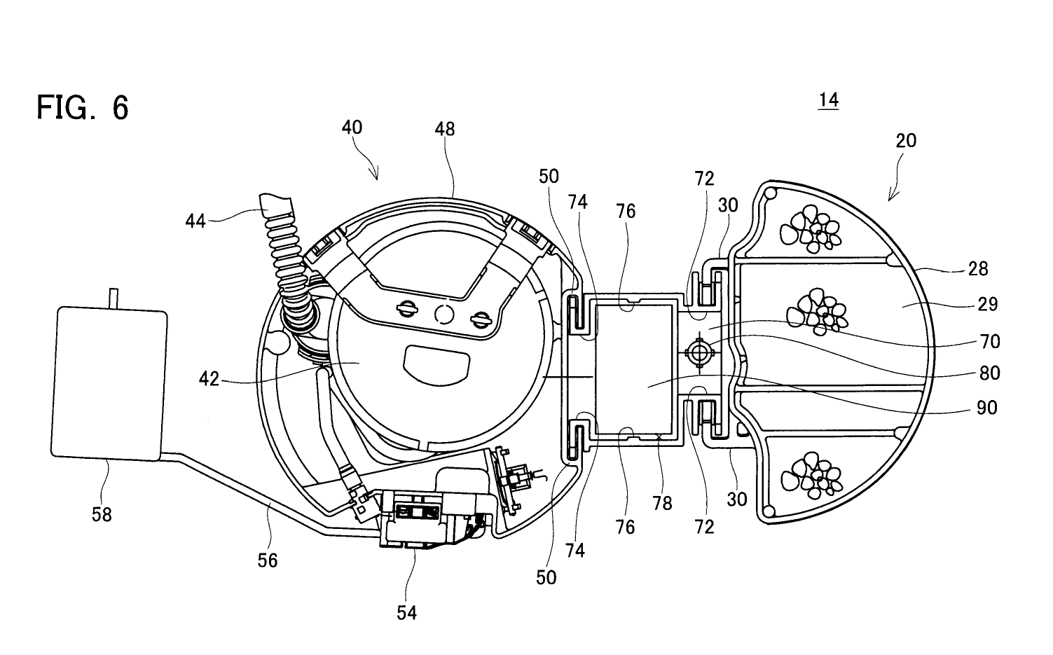

(Embodiment 3) A fuel supply device according to Embodiment 3 of the present invention will be described with reference to drawings. FIG. 5 shows a front view of the fuel supply device 14 according to Embodiment 3. FIG. 6 is a cross sectional view taken along a line VI-VI indicated in FIG. 5, and shows a transverse section of the fuel supply device 14 of Embodiment 3. The fuel supply device 14 of Embodiment 3 shown in FIGS. 5 and 6 may be obtained by modifying the partial structure of the fuel supply device 10 of Embodiment 1 shown in FIGS. 1 and 2. In the description about the fuel supply device 14 of Embodiment 3 provided below, components which are in common with those of the fuel supply device 10 of Embodiment 1 are designated by the same reference numerals, and the descriptions related to those components may be abbreviated.

As shown in FIGS. 5 and 6, the first connecting portions 30 of the upper unit 20 are shortened in the horizontal direction in the fuel supply device 14 of Embodiment 3 as compared with those in the fuel supply device 10 of Embodiment 1, and the coupling member 70 is accordingly moved to an upper unit 20 side by an amount equivalent to the shortened portion of the first connecting portions 30, while the coupling member 70 extends toward the second connecting portions 50 of the lower unit 40. Then, the hollow 78 that extends in the vertical direction is formed in the coupling member 70, and the control module 90 is disposed within the hollow 78. The hollow 78 where the control module 90 is disposed communicates with the inner space of the fuel tank 200 at both upper and lower ends of the hollow 78 in the vertical direction, thereby realizing the structure in which the fuel 210 in the fuel tank 200 can easily flow in and flow out of the hollow 78. In addition, the protrusions 76 protruding toward the control module 90 in the above-described hollow 78 are formed on the coupling member 70, to maintain the gap between the coupling member 70 and the control module 90.

In the fuel supply device 14 of Embodiment 3, because the control module 90 is disposed inside the fuel tank 200 as with the fuel supply device 10 of Embodiment 1, the control module 90 is directly cooled by the fuel 210 in the fuel tank 200. In this way, an abnormal rise in temperature of the control module 90 can be prevented.

Further, the hollow 78 where the control module 90 is disposed communicates with the inner space of the fuel tank 200 at the upper and lower ends of the hollow 78 in the vertical direction, and the gap between the coupling member 70 and the control module 90 that serves as the path for the fuel 210 to flow is maintained by the protrusions 76 formed on the coupling member 70. According to the above-described configurations, the fuel 210 constantly flows through the hollow 78 where the control module 90 is disposed, to thereby sufficiently cool down the control module 90.

Also, in the fuel supply device 14 of Embodiment 3, the control module 90 is disposed between the upper unit 20 and the lower unit 40 in the horizontal direction (refer to FIG. 5) as with the fuel supply device 10 of Embodiment 1. In other words, the upper unit 20 is arranged on one side (the right side in FIG. 5) of the control module 90 in the horizontal direction, while the lower unit 40 is arranged on the other side (the left side in FIG. 5) of the control module 90 in the horizontal direction. In this arrangement, even when the fuel 210 intensely sways in the fuel tank 200, the swaying of the fuel 210 is effectively blocked in the vicinity of the control module 90, so that strong collision of the fuel 210 with the control module 90 along the aforementioned horizontal direction is prevented.

Further, in the fuel supply device 14 of Embodiment 3, the control module 90 is disposed in the hollow 78 formed in the coupling member 70 to establish a structure in which the control module 90 is surrounded by the lower unit 40 and the coupling member 70 in a horizontal plane that includes the aforementioned horizontal direction. As a result, even when the fuel 210 intensely sways in the fuel tank 200, the swaying of the fuel 210 is highly restricted in the hollow 78 where the control module 90 is disposed. Therefore, the strong collision between the fuel 210 and the control module 90 along any direction within the horizontal plane thereof is surely prevented.

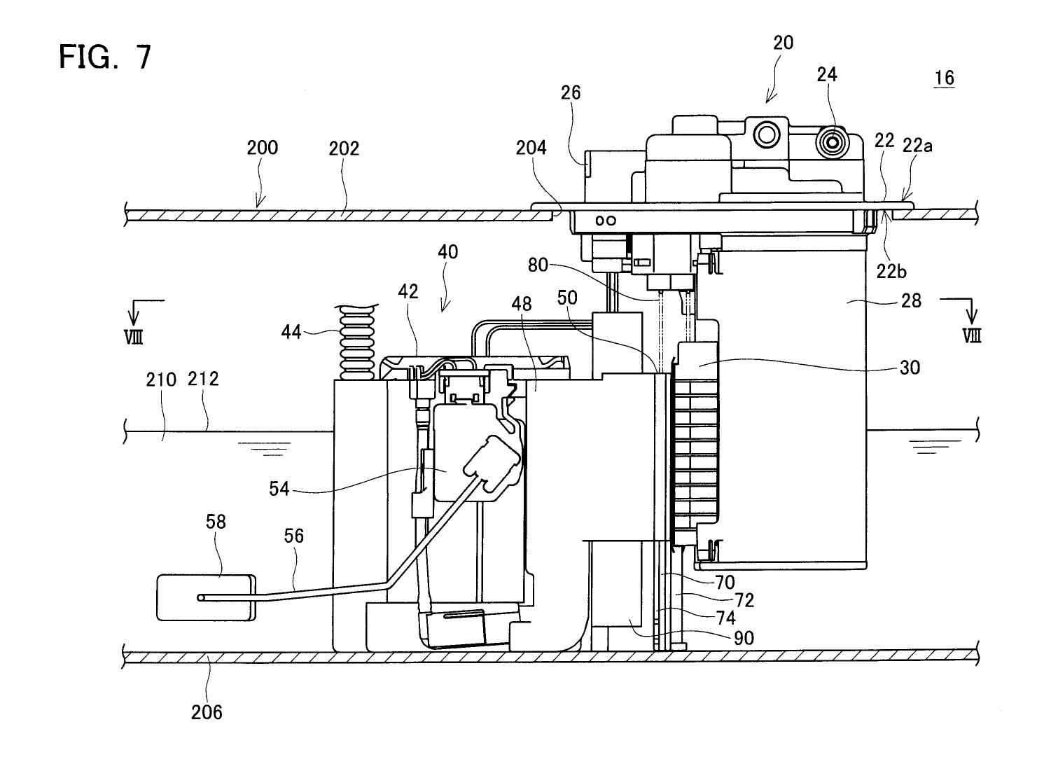

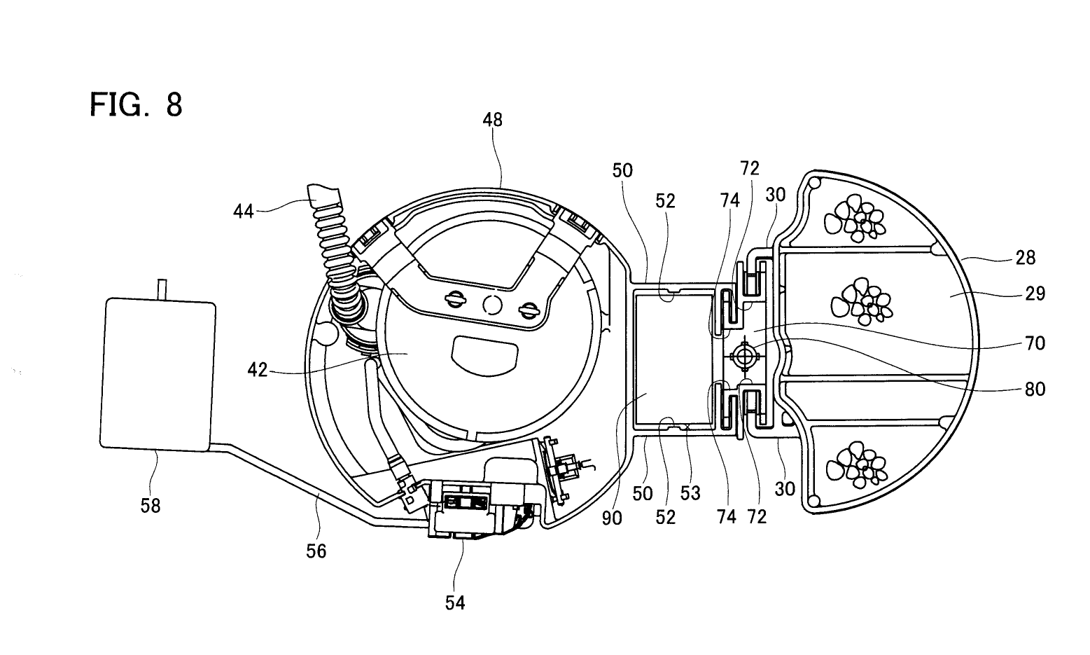

(Embodiment 4) A fuel supply device according to Embodiment 4 of the present invention will be described with reference to drawings. FIG. 7 shows a front view of the fuel supply device 16 of Embodiment 4. FIG. 8 is a cross sectional view taken along a line VIII-VIII indicated in FIG. 7, and shows a transverse section of the fuel supply device 16 of Embodiment 4. The fuel supply device 16 of Embodiment 4 shown in FIGS. 7 and 8 may be obtained by modifying the partial structure of the fuel supply device 10 of Embodiment 1 shown in FIGS. 1 and 2. In the description about the fuel supply device 16 of Embodiment 4 provided below, components which are in common with those in the fuel supply device 10 of Embodiment 1 are designated by the same reference numerals, and the descriptions related to those components may be abbreviated.

As shown in FIGS. 7 and 8, the first connecting portions 30 of the upper unit 20 are shortened in the horizontal direction in the fuel supply device 16 of Embodiment 4 as compared with those in the fuel supply device 10 of Embodiment 1, and the coupling member 70 is accordingly moved to the upper unit 20 side by the amount equivalent to the shortened portion, while the second connecting portions 50 of the lower unit 40 extend toward the coupling member 70 along the peripheral sides of the control module 90. Then, a hollow 53 that extends in the vertical direction is formed between the second connecting portions 50 serving as a pair which extend from the lower unit 40, and the control module 90 is disposed within the hollow 53. The hollow 53 where the control module 90 is disposed communicates with the inner space of the fuel tank 200 at both upper and lower ends of the hollow 53 in the vertical direction, thereby realizing the structure in which the fuel 210 in the fuel tank 200 can easily flow in and flow out of the hollow 53. In addition, protrusions 52 protruding toward the control module 90 in the above-described hollow 53 are formed on the second connecting portions 50 of the pair which extend from the lower unit 40, to maintain a gap between the pair of the second connecting portions 50 and the control module 90.

In the fuel supply device 16 of Embodiment 4, because the control module 90 is disposed inside the fuel tank 200 as with the fuel supply device 10 of Embodiment 1, the control module 90 is directly cooled by the fuel 210 in the fuel tank 200. In this way, the abnormal rise in temperature of the control module 90 can be prevented.

Further, the hollow 53 where the control module 90 is disposed communicates with the inner space of the fuel tank 200 at the upper and lower ends of the hollow 53 in the vertical direction, and the gap between the pair of the second connecting portions 50 and the control module 90 is maintained by the protrusions 52 formed on the pair of the second connecting portions 50. According to the above-described configurations, the fuel 210 constantly flows through the hollow 53 where the control module 90 is disposed, to thereby sufficiently cool down the control module 90.

Also, in the fuel supply device 16 of Embodiment 4, the control module 90 is disposed between the upper unit 20 and the lower unit 40 in the horizontal direction (refer to FIG. 7) as with the fuel supply device 10 of Embodiment 1. In other words, the upper unit 20 is arranged on one side (the right side in FIG. 7) of the control module 90 in the horizontal direction, while the lower unit 40 is arranged on the other side (the left side in FIG. 7) of the control module 90 in the horizontal direction. In this arrangement, even when the fuel 210 intensely sways in the fuel tank 200, the swaying of the fuel 210 is effectively blocked in the vicinity of the control module 90, so that strong collision of the fuel 210 with the control module 90 in the aforementioned horizontal direction is prevented.

Further, in the fuel supply device 16 of Embodiment 4, the control module 90 is disposed in the hollow 53 formed between the second connecting portions 50 of the pair extended from the lower unit 40, to establish the structure in which the control module 90 is surrounded in the horizontal plane by the lower unit 40 and the coupling member 70. As a result, even when the fuel 210 intensely sways in the fuel tank 200, the swaying of the fuel 210 is highly restricted in the hollow 53 where the control module 90 is disposed. Therefore, the strong collision between the fuel 210 and the control module 90 along any direction within the horizontal plane thereof is surely prevented.

The configuration in which the strong collision between the fuel 210 and the control module 90 along any direction within the horizontal plane is to be prevented may be materialized simply by one of the upper unit 20, lower unit 40 and coupling member 70, or by combination of the aforementioned members as indicated in the aforelisted embodiments.

Further, in the aforelisted embodiments, examples in which the control module 90 is fully surrounded in the horizontal directions, and the hollow 34, 78, 53 are horizontally closed; however, the employment of the present teachings is not restricted to the aforesaid embodiments. The hollow may be horizontally open at least in parts, along the vertical direction. Moreover, in the aforelisted embodiments, the control module 90 is fully disposed inside the hollow that is formed within one of the upper unit 20, lower unit 40 and coupling member 70. However, a plurality of components (e.g., two or more of the upper unit 20, lower unit 40 and coupling member 70) may comprise a hollow or a concave which may serve at least in part as a hollow. The hollow in which the control module 90 is to be disposed may be constructed of hollows (or concaves) formed on a plurality of components.

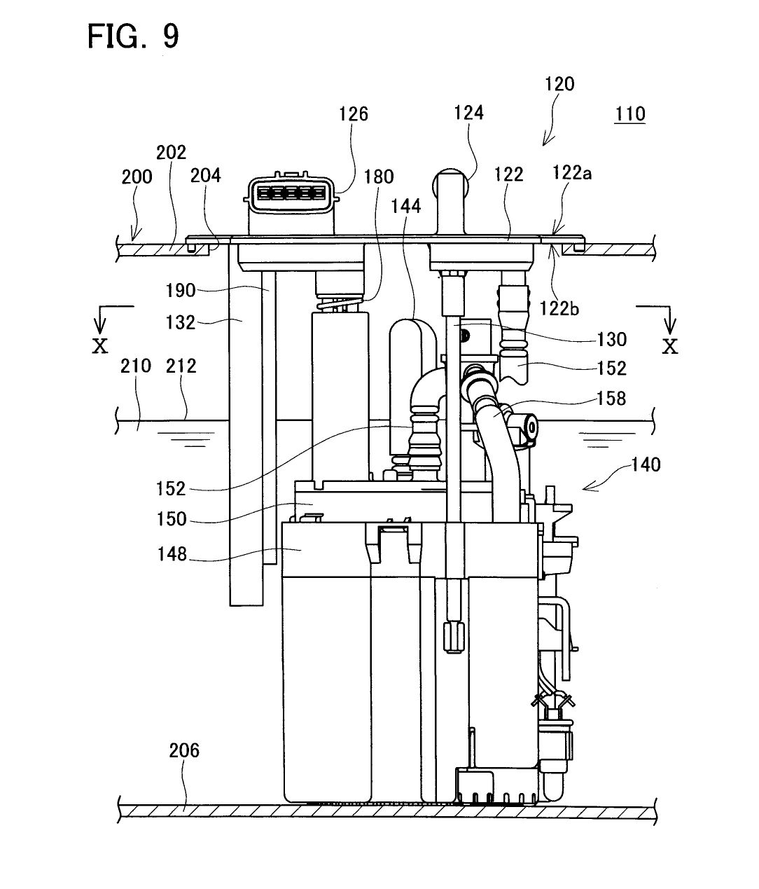

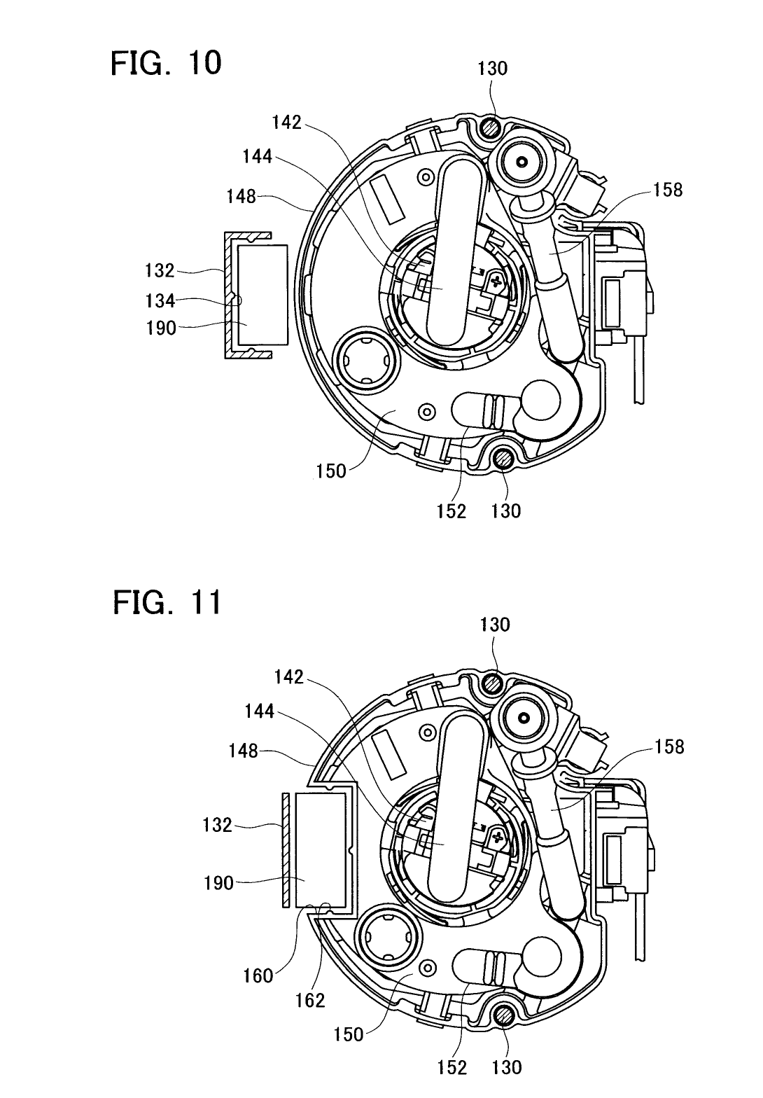

(Embodiment 5) A fuel supply device according to Embodiment 5 of the present invention will be described with reference to drawings. FIG. 9 shows a front view of the fuel supply device 110 of Embodiment 5. FIG. 10 is a cross sectional view taken along a line X-X indicated in FIG. 9, and shows a transverse section of the fuel supply device 110 according to Embodiment 5. As shown in FIG. 9, the fuel supply device 110 of Embodiment 5 is attached to the fuel tank 200 for an automobile or the like for supplying fuel 210 stored in the fuel tank 200 to a combustion engine, such as the engine of the automobile. Here, the fuel 210 is a liquid fuel such as gasoline, and the fluid level 212 of the fuel 210 is generally unique in the horizontal direction. It should be noted that, in FIG. 9, a right and left direction corresponds to the horizontal direction, while a top and bottom direction corresponds to the vertical direction.

As shown in FIGS. 9 and 10, the fuel supply device 110 of Embodiment 5 is composed mainly of an upper unit 120, a lower unit 140, and a control module 190. The control module 190 is fixed to the upper unit 120. Note that the control module 190 may instead be fixed to the lower unit 140. A spring 180 for biasing the lower unit 140 against the bottom surface 206 of the fuel tank 200 is inserted between the upper unit 120 and the lower unit 140.

The upper unit 120 is installed in the installation hole 204 formed on the upper surface 202 of the fuel tank 200, and mainly composed of a set place 122, which serves as a cover member for closing the installation hole 204. The set plate 122 is made of resin material.

An exhaust port 124 from which the fuel 210 is discharged and a connector 126 for establishing electrical connection with the external control device are mounted on an upper surface 112a side of the set plate 122. The connector 126 is electrically connected to the control module 190.

One pair of connecting shafts 130 extending downward in the vertical direction to the lower unit 140 and a cover unit 132 similarly extending downward in the vertical direction are mounted on a lower surface 122b side of the set plate 122. The pair of the connecting shafts 130 connects the upper unit 120 and the lower unit 140. The cover unit 132 has, in cross section thereof, a shape which covers the control module 190 on three sides in the horizontal direction. A protrusion 134 protruded toward the control module 190 is provided to each side face of the cover unit 132 opposing the control module 190, to thereby maintain a gap between the cover unit 132 and the control module 190.

The lower unit 140 is placed inside the fuel tank 200, and, more specifically, disposed on the bottom surface 206 of the fuel tank 200. The lower unit 140 mainly includes a fuel pump 142, a reservoir container 148, and a filter 150. The fuel pump 142, which is housed in the reservoir container 148, takes in fuel contained in the reservoir container 148 and delivers the fuel via a pipe conduit 144 into the filter 150 where foreign objects are removed from the fuel 210. After passing through the filter 150, the fuel 210 is discharged through a pipe conduit 152 from the exhaust port 124 of the set plate 122. Still more, a pressure regulator and a jet pump (both of which are not illustrated) are connected to a pipe conduit 158 between the filter 150 and the exhaust port 124 of the set plate 122. Therefore, the pressure of the fuel 210 to be discharged from the exhaust port 124 is subjected to decompression adjustment, and the fuel 210 is reserved in the reservoir container 148. The fuel pump 142 is electrically connected to the control module 190, and operation of the fuel pump 142 is controlled by the control module 190. It should be noted that, in accordance with the design of the fuel tank 200 or the fuel supply device 110, the fuel pump 142 may instead be arranged on the upper unit 120.

In the fuel supply device 110 of Embodiment 5, because the control module 190 is disposed inside the fuel tank 200 as with the fuel supply device 10 of Embodiment 1, the control module 190 is directly cooled by the fuel 210 in the fuel tank 200. In this way, the abnormal rise in temperature of the control module 190 can be prevented. Moreover, because the gap is maintained between the cover unit 132 and the control module 190 by the protrusions 134 of the cover unit 132, the cooling of the control module 190 is not hindered by the cover unit 132.

In the fuel supply device 110 of Embodiment 5, the control module 190 is disposed between the cover unit 132 of the upper unit 120 and the lower unit 140 in the horizontal direction (refer to FIG. 9). In other words, the cover unit 132 of the upper unit 120 is arranged on one side (the left side in FIG. 9) of the control module 190 in the horizontal direction, while the lower unit 140 is arranged on the other side (the right side in FIG. 9) of the control module 190 in the horizontal direction. In this arrangement, even when the fuel 210 intensely sways in the fuel tank 200, the swaying of the fuel 210 is blocked in the vicinity of the control module 190, so that strong collision of the fuel 210 with the control module 190 in the horizontal direction is prevented.

Further, the fuel supply device 110 of Embodiment 5 has a structure in which the control module 190 is surrounded horizontally by the cover unit 132 of the upper unit 120 and the lower unit 140. As a result, even when the fuel 210 intensely sways in the fuel tank 200, the swaying of the fuel 210 is highly restricted in the vicinity of the control module 190. Therefore, the strong collision between the fuel 210 and the control module 190 along any direction within the horizontal plane thereof is surely prevented.

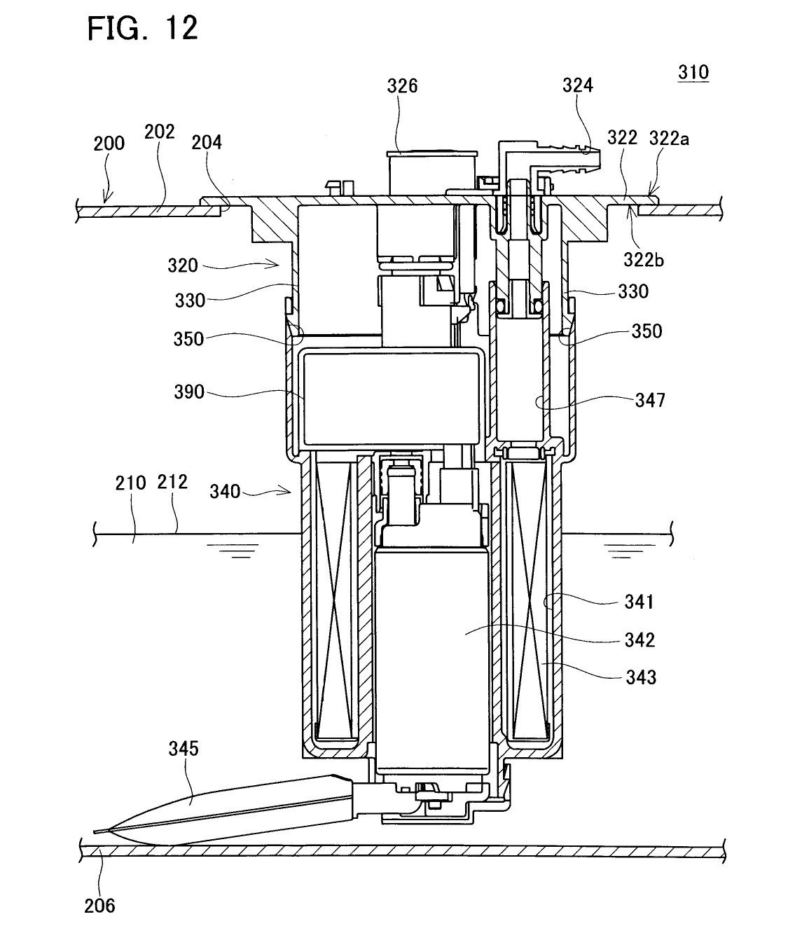

FIG. 11 shows a modification example of the fuel supply device 110 of Embodiment 5. In this modification example, a recessed area 162 is formed on the lower unit 140 as shown in FIG. 11, and the control module 190 is disposed in the recessed area 162. Further, the shape of the cover unit 132 is changed to a shape of a flat plate. In this structure, the control module 190 is also surrounded horizontally by the cover unit 132 of the upper unit 120 and the lower unit 140. It can also be said that the recessed area 162 of the lower unit 140 and the cover unit 132 of the upper unit 120 constructs a hollow in which the control module 190 is disposed. As a result, even when the fuel 210 intensely sways in the fuel tank 200, the swaying of the fuel 210 is highly restricted in the vicinity of the control module 190. Therefore, the strong collision of the fuel 210 with the control module 190 is surely prevented. Fuel 210 flows in and out of the opened portions of the hollow (e.g., the top and bottom openings in the vertical direction and the opening portions between the recessed area 162 and cover unit 132 in the horizontal direction) and flowing therein to disperse heat of the control module 190. Further, the cover unit 132 shown in FIG. 10 may instead be employed together with the recessed area 162 shown in FIG. 11 so that the control module 190 can be disposed in between the a part of the upper unit 120 (in this case the cover unit 132) and a part of the lower unit 140 (in this case the recessed area 162). Moreover, as shown in the above embodiment, a hollow that includes an opening, or a notch, along the vertical direction may be formed on at least one of an upper unit, lower unit, and coupling member.

(Embodiment 6) A fuel supply device according to Embodiment 6 of the present invention will be described with reference to a drawing. FIG. 12 shows a cross sectional view of the fuel supply device 310 of Embodiment 6 is depicted. As shown in FIG. 12, the fuel supply device 310 of Embodiment 6 is attached to the fuel tank 200 for an automobile or the like for supplying the fuel 210 stored in the fuel tank 200 to the combustion engine such as the engine of the automobile. Here, the fuel 210 is a liquid fuel such as gasoline, and the fluid level 212 of the fuel 210 is generally unique in the horizontal direction. Note that a right and left direction of FIG. 12 corresponds to the horizontal direction, while a top and bottom direction of FIG. 12 corresponds to the vertical direction.

As shown in FIG. 12, the fuel supply device 310 of Embodiment 6 mainly composes an upper unit 320, a lower unit 340, and a control module 390. The control module 390 is disposed between the upper unit 320 and the lower unit 340. Further, the control module 390 is fixed onto the lower unit 340. In this regard, the control unit 390 may be configured so as to be fixed onto the upper unit 320.

The upper unit 320 is installed in the installation hole 204 formed on the upper surface 202 of the fuel tank 200. The upper unit 320 is mainly composed of a set plate 322 which serves as a cover member for closing the installation hole 204. The set plate 322 is made of resin material.

An exhaust port 324 from which the fuel 210 is discharged and a connector 326 for establishing electrical connection with the external control equipment are mounted on an upper surface 322a side of the set plate 322. The connector 326 is electrically connected to the control module 390.

One pair of coupling portions 330 which extend downward in the vertical direction to the lower unit 340 are mounted on a lower surface 322b side of the set plate 322. The coupling portions 330 of the pair are provided, at their respective ends, with lugs which are fitted in engaging portions 350 formed on the lower unit 340.

The lower unit 340 is placed inside the fuel tank 200. The lower unit 340 is mainly composed of a filter case 341 formed in a cylindrical shape, a fuel pump 342 installed in an inner hole of the filter case 341, and a first filter 345. A second filter 343 formed in a cylindrical shape is provided in the filter case 341. The fuel pump 342 is electrically connected to the control module 390, and operation of the fuel pump 342 is controlled by the control module 390.

The fuel pump 342 sucks in the fuel 210 stored in the fuel tank 200 through the first filter 345 where relatively large foreign objects are removed from the fuel 210. The fuel 210 sucked by the fuel pump 342 is delivered into the filter case 341. After minute foreign objects are removed through the second filter 343 from the fuel 210 delivered into the filter case 341, the fuel 210 is sent via a connecting pipe conduit 347 to an upper unit 320 side and discharged from the exhaust port 324 of the upper unit 320. The exhaust port 324 is connected via a pipe conduit or other conduits (not illustrated) to the external combustion engine.

In the fuel supply device 310 of Embodiment 6, because the control module 390 is also disposed inside the fuel tank 200 as with the fuel supply device 10 of Embodiment 1, the control module 390 is directly cooled by the fuel 210 contained in the fuel tank 200. In this way, the abnormal rise in temperature of the control module 390 can be prevented.

Further, in the fuel supply device 310 of Embodiment 6, the control module 390 is disposed between the upper unit 320 and the lower unit 340. In addition, the connecting pipe conduit 347 which extends from the lower unit 340 to the upper unit 320 is arranged in the vertical direction of the control module 390. In the configuration as described above, even when the fuel 210 intensely sways in the fuel tank 200, the swaying of the fuel 210 is blocked in the vicinity of the control module 390, so that strong collision of the fuel 210 against the control module 390 is effectively prevented.

Although the specific embodiments of the present invention have been described above, the embodiments are disclosed to merely illustrate some possibilities of the invention, and should not be regarded as limitations to the scope of accompanying claims of the present invention. The art set forth in the claims includes transformations and modifications to the specific examples set forth above.

The technical elements disclosed in the specification or the drawings may be utilized separately or in all types of combinations, and are not limited to the combinations set forth in the claims at the time of filing of the application. Furthermore, the art disclosed herein may be utilized to simultaneously realize a plurality of aims or to realize one of these aims.

What is claimed is:

1. A fuel supply device comprising:
an upper unit which is fixed to an installation hole formed on an upper surface of a fuel tank;
a lower unit which is disposed within the fuel tank;
a fuel pump arranged on one of the upper unit and the lower unit, and
a control module which is disposed within the fuel tank to control operation of the fuel pump, wherein
a part of the upper unit is located on one side of the control module in a horizontal direction with respect to the control module, and
a part of the lower unit is located on the other side of the control module in the horizontal direction.

2. A fuel supply device as in claim 1, wherein
at least a part of the control module is surrounded by at least one of the upper unit and the lower unit in the horizontal direction.

3. A fuel supply device as in claim 1, wherein
a hollow that extends in a vertical direction is formed within one of the upper unit and the lower unit, and
at least a part of the control module is disposed in the hollow formed within one of the upper unit and the lower unit.

4. A fuel supply device as in claim 3, wherein
the hollow pierces through at least one of the upper unit and the lower unit in the vertical direction.

5. A fuel supply device as in claim 1, further comprising
a coupling member that couples the upper unit and the lower unit in a manner in which relative positions of the upper unit and the lower unit are changeable, wherein
at least a part of the control module is surrounded by at least one of the upper unit, the lower unit, and the coupling member in the horizontal direction.

6. A fuel supply device as in claim 5, wherein
the upper unit comprises at least one first connecting portion that slidably connects the upper unit to the coupling member,
a hollow that extends in a vertical direction is formed within at least one of the first connecting portion of the upper unit, and
at least a part of the control module is disposed in the hollow formed within at least one of the first connecting portion of the upper unit.

7. A fuel supply device as in claim 6, wherein
the hollow pierces through the at least one first connecting portion of the upper unit in the vertical direction.

8. A fuel supply device as in claim 5, wherein
the lower unit comprises at least one second connecting portion that slidably connects the lower unit to the coupling member,
a hollow that extends in a vertical direction is formed within at least one of the second connecting portion of the lower unit, and
at least a part of the control module is disposed in the hollow formed within at least one of the second connecting portion of the lower unit.

9. A fuel supply device as in claim 8, wherein
the hollow pierces through at least one of the second connecting portion of the lower unit in the vertical direction.

10. A fuel supply device as in claim 5, wherein
a hollow that extends in a vertical direction is formed within the coupling member, and
at least a part of the control module is disposed in the hollow formed within the coupling member.

11. A fuel supply device as in claim 10, wherein
the hollow pierces through the coupling member in the vertical direction.

12. A fuel supply device as in claim 1, wherein
a neighboring area of the control module communicates with an internal space of the fuel tank.
